(19) United States
(12) Patent Application Publication
(10) Pub. No.: US 2004/0059756 A1
(43) Pub. Date: Mar. 25, 2004

(54) System for processing examinational information of medical image, and data processing apparatus in such system

(75) Inventor: Naoki Mochizuki, Minamiashigara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/665,140

(22) Filed: Sep. 22, 2003

(30) Foreign Application Priority Data
Sep. 20, 2002 (JP) 2002-276075
Jun. 23, 2003 (JP) 2003-177953

(51) Int. Cl. G06F 12/00

(52) U.S. Cl. 707/201

(57) ABSTRACT

Examinational information for identifying non-DICOM-format images obtained by a medical imaging apparatus can be acquired whenever necessary. A medical imaging apparatus outputs character information representing examinational information data received from a server through a terminal and captured medical image data to a data processing apparatus. The data processing apparatus acquires examinational information data corresponding to the medical image data from the server in advance, and stores and manages the examinational information data in a local database of the data processing apparatus. It is thus possible to acquire desired examinational information from the local database whenever necessary to generate DICOM data.

### BACKGROUND OF THE INVENTION

1. Field of the Invention

The present invention relates to a data processing apparatus for merging examinational information data (hereinafter also referred to as “attribute information data”) which is used to identify an image (hereinafter referred to as “medical image” or “medical diagnostic image”) that is produced by a medical imaging apparatus (modality) and data of the medical image (hereinafter referred to as “medical image data”) to convert them into data of a predetermined format, and a system for processing examinational information of medical images, which system includes such a data processing apparatus.

2. Description of the Related Art

Heretofore, there has been put to use a conventional medical image network system that comprises a medical imaging apparatus such as an MRI (Magnetic Resonance Imaging) apparatus or the like, an RIS (Radiology Information System) server for storing and managing examinational information of medical images that are produced by the medical imaging apparatus as data (hereinafter referred to as “examinational information data”), a terminal which uses the RIS server, and a DICOM (Digital Image Communication Medicine) converter, which are interconnected by a communication link.

The examinational information of a medical image referred above represents information for identifying a medical image such as a patient's name, a patient's ID (Identification), or an examined spot (examined region/imaged region), etc. The DICOM converter has a function to receive data of a medical image from the medical imaging apparatus and examinational information data from the RIS server, and converts the received data into data (DICOM data) in a format (DICOM format) according to DICOM standards.

For inspecting a patient, e.g., imaging a local region of a patient, with the medical imaging apparatus using the above medical image network system, the operator operates the terminal, which is positioned near the medical imaging apparatus, to acquire the examinational information data that represents the information of the patient from the RIS server.

When the patient is examined with the medical imaging apparatus, data of the image (hereinafter referred to as “image data”) that is produced by the medical imaging apparatus and includes an image of the inspected region and character information represented by the examinational information is transmitted to the DICOM converter. When the examination of the patient with the medical imaging apparatus is finished, the terminal associated with the medical imaging apparatus indicates the end of the examination to the IRS server via the communication link.

The DICOM converter loads the image data received from the medical imaging apparatus in its own memory, reads the character information represented by the examinational information such as the patient's name, etc. from the loaded image data according to a character recognition program, and converts the read character information into examinational information data. Then, the DICOM converter merges the examinational information data and the image data, and transmits the merged data as DICOM-format data to a printer or the like (see Japanese laid-open patent publication No. 11-88589 for details).

The conventional medical image network system, however, is unable to obtain examinational information other than the character information contained in the image data (the image represented by the image data includes the image of the examined region and the character information represented by the examinational information).

Furthermore, since the character information is read using the character recognition program, there is a possibility that the character information may be read in error.

Usually, for the purpose of shortening the processing time, the image data loaded in the memory of the DICOM converter is displayed as an image on a display panel, and the operator specifies a character information area on the image displayed on the display panel to extract the desired character information from the image. However, because the position of the character information in the image displayed on the display panel differs among different individual medical imaging apparatus, the operator needs to perform a tedious and time-consuming process of specifying a character information area for each individual medical imaging apparatus.

One solution to the above problems is to ask the RIS server to send the examinational information data when the DICOM converter converts the data. However, when the terminal associated with the medical imaging apparatus indicates the end of the examination to the RIS server, the RIS server may operate to delete the examinational information data from its file. If the RIS server has already deleted the examinational information data, the examinational information data is no longer available from the RIS server.

### SUMMARY OF THE INVENTION

It is therefore an object of the present invention to provide a data processing apparatus which is capable of acquiring, whenever necessary, examinational information which serves to identify an image produced by a medical imaging apparatus, and a system for processing examinational information of medical images, which system includes such a data processing apparatus.

A data processing apparatus according to the present invention merges image data by a medical imaging apparatus and examinational information data from a server into data in a predetermined format. The data processing apparatus has a comparing means for comparing examinational information data newly read from the server and the examinational information data that have already been stored in a local database with each other, and storing the newly read examinational information data into the local database only when the newly read examinational information data have not been stored in the local database.

It is thus possible to acquire desired examinational information from the local database of the data processing apparatus whenever necessary.

The data processing apparatus may further include a periodically data reading means for periodically reading the examinational information data from the server. Therefore, examinational information data can be acquired from the local database even if the examinational information data are deleted from the server when an examination process is put to an end.

The data processing apparatus may further include a list displaying means for displaying, on a display unit, a list of examinational information that is produced by merging examinational information data newly read from the server and examinational information data that have already been stored in the local database. With this arrangement, since the user of the data processing apparatus may refer to only one list displayed on the display unit, without the need for switching between and selecting a plurality of lists.

According to the present invention, there is also provided a system for processing examinational information of medical images, the system having a server for storing and managing examinational information data for identifying an image obtained by a medical imaging apparatus, and a data processing apparatus for merging data of the image obtained by the medical imaging apparatus and the examinational information data from the server into data in a predetermined format, the server and the data processing apparatus being connected to each other by a communication link, the data processing apparatus comprising a local database for storing and managing the examinational information data, and a comparing means for comparing examinational information data newly read from the server and the examinational information data that have already been stored in the local database with each other, and storing the newly read examinational information data into the local database only when the newly read examinational information data have not been stored.

The above system makes it possible to acquire desired examinational information for identifying images obtained by the medical imaging apparatus from the local database of the data processing apparatus whenever necessary.

The system may further includes a terminal connected to the communication link for receiving and outputting examinational information data that have been stored in the server when the medical imaging apparatus is used, and a communication monitoring device connected to the communication link for logging communication data transmitted between the terminal and the server. Based on the logged communication data, the examinational information which is highly likely to have been used by the medical imaging apparatus, i.e., the examinational information which the terminal has acquired from the server, can be acquired and used.

The communication monitoring device may transmit the examinational information data to the data processing apparatus when the communication monitoring device detects reception by the terminal of the examinational information data from the server. With this arrangement, the examinational information data can reliably be stored in the local database of the data processing apparatus.

The communication monitoring device may send a command to the server to copy predetermined data included in the examinational information data stored in the server to the local database when the communication monitoring device detects data communications between the terminal and the server. With this arrangement, the examinational information data can also reliably be stored in the local database of the data processing apparatus.

The above and other objects, features, and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1 is a schematic view of a medical image network system incorporating a system for processing examinational information of medical images according to an embodiment of the present invention;

FIG. 2 is a block diagram of the medical image network system shown in FIG. 1;

FIG. 3 is a block diagram of functions that are performed by a data processing apparatus of the medical image network system shown in FIGS. 1 and 2;

FIGS. 4 and 5 are flowcharts of an operation sequence of the medical image network system shown in FIGS. 1 and 2;

FIG. 6 is a block diagram of a medical image network system incorporating a system for processing examinational information of medical images according to another embodiment of the present invention;

FIGS. 7 and 8 are flowcharts of an operation sequence of the medical image network system shown in FIG. 6;

FIG. 9 is a flowchart of another operation sequence of the medical image network system shown in FIG. 6; and

FIG. 10 is a flowchart of still another operation sequence of the medical image network system shown in FIG. 6.

### DESCRIPTION OF THE PREFERRED EMBODIMENTS

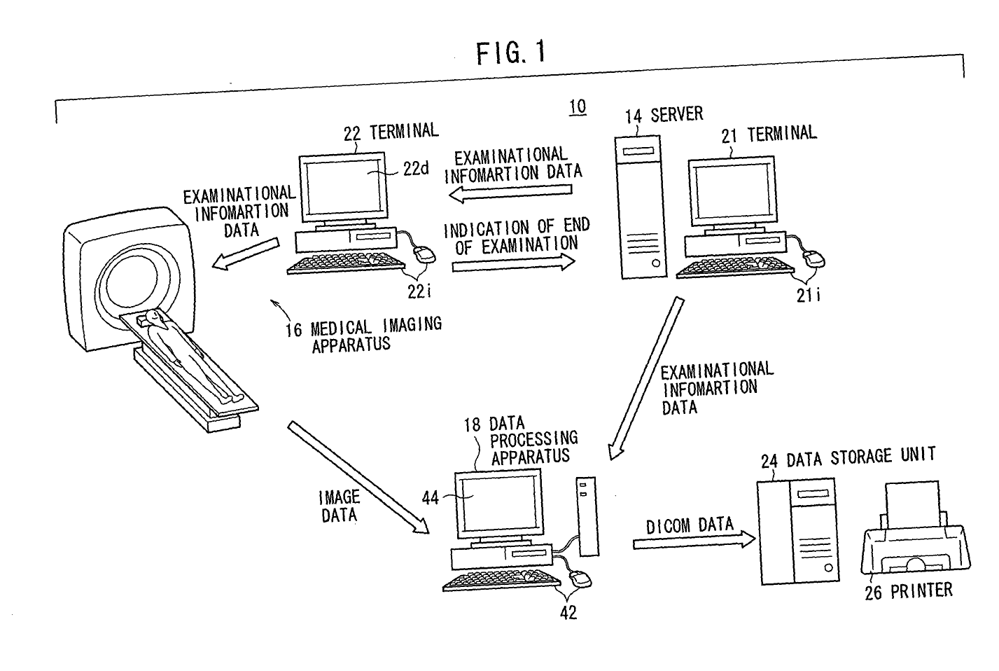

An embodiment of the present invention will be described with reference FIGS. 1 through 10. Like or corresponding parts are denoted by like or corresponding reference characters throughout views.

FIG. 1 schematically shows a medical image network system 10 incorporating a system for processing examinational information of medical images according to an embodiment of the present invention. The medical image network system 10 may be installed in general hospitals, university hospitals, health insurance centers, etc.

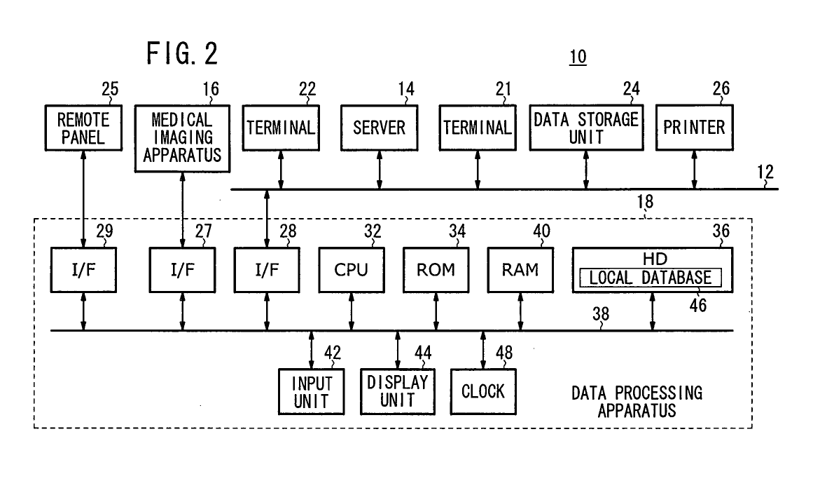

FIG. 2 shows in block form the medical image network system 10 illustrated in FIG. 1.

As shown in FIGS. 1 and 2, the medical image network system 10 basically comprises a server 14 for storing and managing examinational information as data (hereinafter referred to as “examinational information data”), a medical imaging apparatus 16 for capturing an image of an examined region of a patient, merging the captured image (examinational image) and character information represented by the examinational information data, and outputting the merged data as image data, and a data processing apparatus 18 disposed physically in the vicinity of the medical imaging apparatus 16 for merging the image data output from the medical imaging apparatus 16 and the examinational information data output from the server 14, and converting the merged data into data in a DICOM format (also referred to as “DICOM data”).

As shown in FIG. 2, the medical imaging apparatus 16 is locally connected to the data processing apparatus 18 by an interface 27. The data processing apparatus 18 and various devices including the server 14 are connected to each other by a communication link 12 such as a LAN (Local Area Network) or the like. The medical imaging apparatus 16 may also be connected to the communication link 12. The medical imaging apparatus 16 has input units, such as a keyboard and a magnetic card reader, and a display unit (not shown).

The examinational information that is stored and managed by the server 14 includes information representing a patient's name, a patient's ID, a gender, a date of birth, a doctor in charge, an examined spot (examined region), a medical imaging apparatus ID, an examined date, an examined department (clinical department), an applied radiation dosage, etc.

To the communication link 12, there are connected a server terminal 21 for inputting patient's registered information into the server 14 with an input device such as a keyboard or the like, a terminal 22 (of the server 14) disposed near the medical imaging apparatus 16 for outputting registered information stored in the server 14 as examinational information data through the communication link 12 to a display unit 22d of the terminal 22, a magnetic card, or the like when the medical imaging apparatus 16 is to be used, a data storage unit 24 for storing data in the DICOM format (DICOM data) output from the data processing apparatus 18, and a printer 26 for printing an image based on data in the DICOM format.

A request for printing an image is entered from an input unit 42 of the data processing apparatus 18 or a remote panel 25 as a remote input unit that is disposed near the medical imaging apparatus 16 and connected to the data processing apparatus 18 by a cable and an interface 29.

Each of the server 14, the medical imaging apparatus 16, the data processing apparatus 18, the terminals 21, 22, the data storage unit 24, and the printer 26 has the function of a computer that automatically performs series of calculations and process data according to a program.

If the medical image network system 10 is installed in a medical center such as a hospital, then the medical imaging apparatus 16, the terminal 22, and the remote panel 25 are typically positioned in an image capturing room, the terminal 21 at a reception desk, the data storage unit 24 and the printer 26 in a consultation room, and the server 14 and the data processing apparatus 18 in an administration room.

In the present embodiment, the server 14 comprises an RIS ((Radiology Information System) server for managing patient's names, patient's IDs, and examinational records. Therefore, the terminals 21, 22 function as RIS terminals. In the present embodiment, the medical imaging apparatus 16 comprises a non-DICOM-modality MRI (Magnetic Resonance Imaging) apparatus for outputting an analog video signal representing a medical image (diagnostic image) of an imaged region, i.e., an examined region (diagnosed region) such as a patient's local body region, and transmitting the analog video signal through a cable to the data processing apparatus 18.

The data processing apparatus 18 may comprise a DICOM converter. Data output from the data processing apparatus 18 may be in other formats than the DICOM format, e.g., a postscript format and NEMA (the National Electrical Manufacturers Association) format.

As shown in FIG. 2, the data processing apparatus 18 is connected to the medical imaging apparatus 16 by the interface (I/F) 27. The interface 27 includes an A/D converter for converting an analog video signal supplied from the medical imaging apparatus 16 into a digital video signal representing image data. The data processing apparatus 18 is also connected to the communication link 12 by another interface (I/F) 28. The data processing apparatus 18 has a CPU (Central Processing Unit) 32 which controls all components of the data processing apparatus 18 through a bus 38 based on various programs stored in a ROM (Read Only Memory) 34 and a HD (Hard Disk) 36 while referring to a clock 48. The CPU 32 also performs various image processing sequences, communication processing sequences, and data processing sequences, using a RAM (Random Access Memory) 40 as a working memory.

Furthermore, the CPU 32 interprets input commands supplied from the input unit 42 such as a keyboard, a mouse, etc. and displays an examined image (diagnostic image) on a display unit 44 such as a CRT or the like. The CPU 32 also manages a local database 46 that is assigned a certain area of the hard disk 36 and stores examinational information data received from the server 14 through the communication link 12.

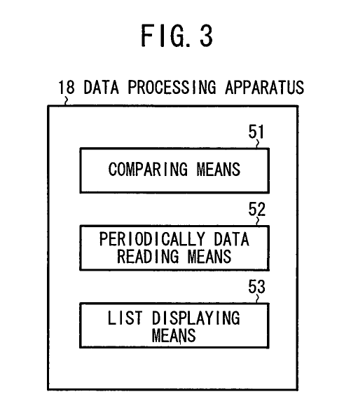

FIG. 3 shows in block form functions that are performed by the data processing apparatus 18 including the CPU 32 that executes programs to process data.

As shown in FIG. 3, the data processing apparatus 18 has a comparing means 51, a periodically data reading means 52, and a list displaying means 53, each serving as a means for performing a certain function.

The comparing means 51 compares examinational information data that is newly read from the server 14 through the communication link 12 with examinational information data that have already been stored in the local database 46, and stores the newly read examinational information data into the local database 46 only when the newly read examinational information data have not been stored in the local database 46.

The periodically data reading means 52 periodically reads examinational information data from the server 14 through the communication link 12.

The list displaying means 53 displays, on the display unit 44, a list of examinational information that is produced by merging examinational information data that are newly read from the server 14 through the communication link 12 and examinational information data that have already been stored in the local database 46.

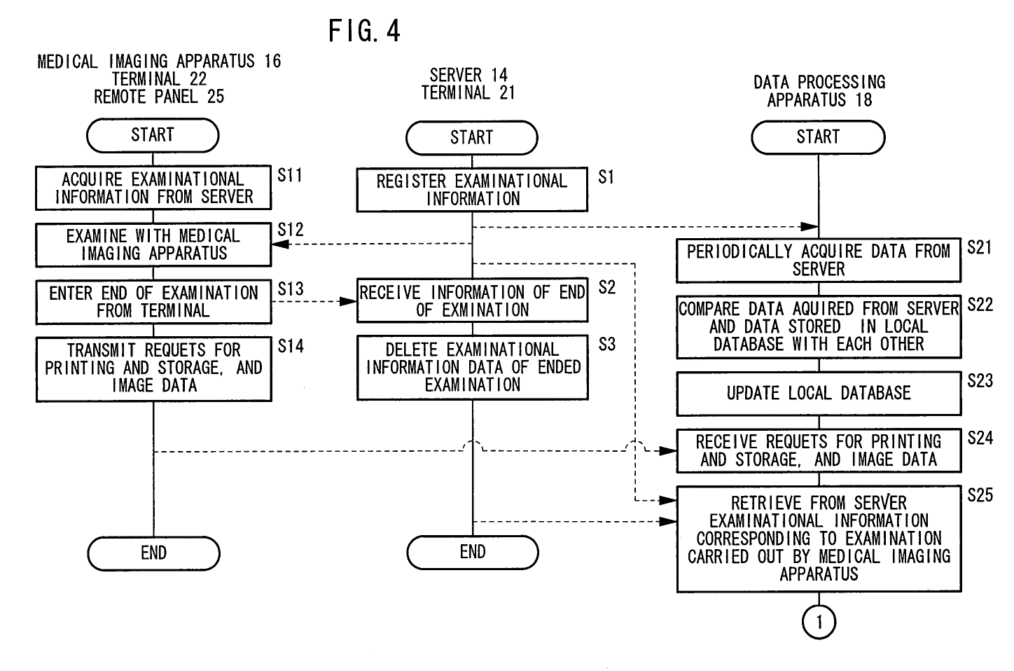

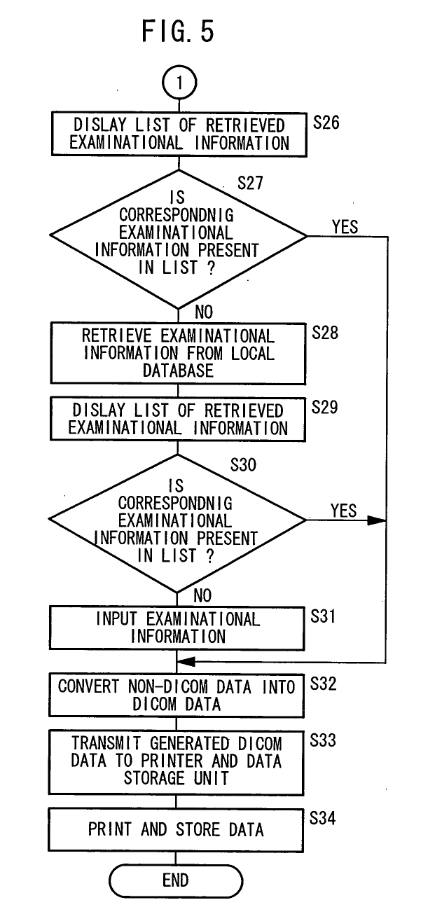

Operation of the medical image network system 10 will be described below with reference to FIGS. 4 and 5 in connection with a process in which a patient who visits a hospital is diagnosed by a doctor, an examined image (diagnosed image) of the patient is captured by an imaging technician, a hard copy of the captured examined image is produced by the printer 26, and DICOM data thereof is stored in the data storage unit 24.

First, the patient is accepted by the reception desk in the hospital, and then goes to a consultation room where the patient is diagnosed by the doctor. If the doctor decides that the patient should need a local body region thereof to be imaged, the doctor puts down the decision on the patient's medical record, which is handed over to the operator of the terminal 21. The terminal 21 is connected to the server 14 through the communication link 12.

The operator sees the description on the patient's medical record and inputs various items of examinational information, including the patient's acceptance number, the patient's name, the patient's ID, the gender, the date of birth, the patient's height and weight, the blood type, the examined department, the examined region, the imaging technician, the examined data, etc., into the terminal 21 using input units 21i thereof, such as a keyboard, a mouse, etc.

The data of the examinational information (hereinafter referred to as “examinational information data”) thus input into the terminal 21 are stored and registered in the server 14 through the communication link 12 in step S1 shown in FIG. 4.

When the patient arrives at the room (image capturing room) where the medical imaging apparatus 16 is installed, the imaging technician operates the medical imaging apparatus 16 by inputting the patient's acceptance number, the patient's name, or the patient's ID into the terminal 22 using input units 22i thereof. Then, the terminal 22 acquires the examinational information data from the server 14 through the communication link 12, and displays the acquired examinational information on the display unit 22d in step S11.

More specifically, while viewing the display unit 22d, the patient's medical record, the patient itself, the imaging technician uses the input units 22i to manually input necessary examinational information data into the medical imaging apparatus 16. If the patient's medical record is in the form of an electronic record, such as a magnetic card record, then the imaging technician operates a magnetic card reader to input necessary examinational information data into the medical imaging apparatus 16. In this manner, the terminal 22 acquires the examinational information data from the server 14 through the communication link 12.

In step S12, the imaging technician operates the medical imaging apparatus 16 to capture an image of the patient's local body region, thus examining the patient with the medical imaging apparatus 16. The medical imaging apparatus 16 merges character information representing the examinational information data and the captured image into image data, and loads the image data into a memory such as a RAM or the like thereof.

The examination of the patient with the medical imaging apparatus 16 is now finished. In step S13, the imaging technician inputs an end of the examination using the medical imaging apparatus 16 from the input units 22i.

In step S14, the imaging technician operates the remote panel 25 to enter a request for printing and storing an image represented by the image data that has been generated by the medical imaging apparatus 16 in step S12. At this time, the image data that has been generated by the medical imaging apparatus 16 is converted by the medical imaging apparatus 16 into an analog video signal, which is then transmitted to the data processing apparatus 18.

The end of the examination using the medical imaging apparatus 16, which has been input in step S13, is received by the server 14 through the communication link 12 in step S2.

Having received the end of the examination, the server 14 deletes the examinational information data that have been registered in step S1 in step S3. The examinational information data are deleted when the end of the examination is received because the storage capacity of a hard disk as a storage device of the server 14 can be saved by deleting the examinational information data that are no longer necessary.

The CPU 32 as it functions as the periodically data reading means 52 of the data processing apparatus 18 periodically acquires new examinational information data (examinational information data newly registered in the server 14) from the server 14 while referring to the clock 48.

The periodic interval, i.e., the interval at which the new examinational information data are to be acquired from the server 14, can be set and changed by the user using the data processing apparatus 18 depending on the frequency with which the examinational information data are to be updated in the server 14, the frequency being variable depending on the number of patients to be examined per unit time and the scale of the facility where the medical image network system 10 is installed.

In the medical image network system 10 according to the present embodiment, the interval at which the new examinational information data are to be acquired from the server 14 is set to a period of time shorter than the minimum period from the time when examinational information data are registered in server 14 in step S1 until the time when the end of the examination is received in step S2. Stated otherwise, the minimum period is a period until the examinational information data input from the terminal 21 in step S1 are deleted from the server 21 in step S3. The interval at which the new examinational information data are to be acquired from the server 14 is set to the period that is shorter than the minimum period and in which examinational information data are present of necessity in the server 14. For example, the new examinational information data are acquired from the server 14 at an interval of 10 minutes. The interval of 10 minutes is employed because it necessarily takes at least 10 minutes to acquire examinational information data that have been registered in the server 14 through the terminal 22 into the medical imaging apparatus 16, inspect the patient (image the patient in the present embodiment) with the medical imaging apparatus 16, and obtain image data of the examined body region with the data processing apparatus 18.

In step S22, the CPU 32 as it functions as the comparing means 51 compares the examinational information data newly read in step S21 and the examinational information data that have already been registered in the local database 46 with each other, and stores the newly read examinational information data into the local database 46 only when the newly read examinational information data have not been stored in the local database 46.

By thus updating the data stored in the local database 46, it is possible to acquire, whenever necessary, examinational information data for identifying images obtained by the medical imaging apparatus 16.

Actually, after the data stored in the local database 46 have been updated in step S23, the doctor or the imaging technician operates the remote panel 25, which is ancillary to the data processing apparatus 18, to enter, in step S14, a request for printing and storing an image represented by the image data that has been generated by the medical imaging apparatus 16.

In step S24, the data processing apparatus 18 receives the request entered in step S14 for printing and storing the image from the remote panel 25, and converts the analog video signal received from the medical imaging apparatus 16 into a digital video signal with the interface 27, and loads image data represented by the digital video signal into the RAM 40. The data processing apparatus 18 displays an image represented by the image data stored in the RAM 40 on the display unit 44.

The image displayed on the display unit 44 comprises character information (the patient's name, the patient's ID, etc.) based on the examinational information data that the terminal 22 has received from the server 14 in step S11 and also an image of the examined spot (examined region) of the patient.

In step S25, the data processing apparatus 18 retrieves the examinational information from the server 14 using the ID (identification information) of the medical imaging apparatus 16 which has been received in step S24 as a retrieval key.

Then, the data processing apparatus 18 displays the examinational information retrieved from the server 14 as a list of images on the display unit 44 in step S26, following the connector 1, shown in FIG. 5.

The data processing apparatus 18 retrieves the examinational information from the server 14 in step S25 for the following reasons: The request for printing and storing an image in step S14 may often be entered before the end of the examination is input in step S13. In such a case, since the examinational information data have not yet been deleted from the server 14 in step S3, the examinational information data may often remain registered in the server 14.

In step S27, the operator, e.g., the imaging technician, of the data processing apparatus 18 visually compares the character information (the patient's name, the patient's ID, etc.) and the image (displayed image) of the examined spot (examined region) of the patient with the list of images on the display unit 44. The character information and the image of the examined spot, and the list of images are displayed as split images on the same screen of the display unit 44. The operator determines whether the list contains the examinational information data corresponding to the displayed image or not, and enters YES (affirmative) or NO (negative) with the input unit 42.

If the negative answer is entered, then the data processing apparatus 18 retrieves examinational information data from the local database 46 using the ID of the medical imaging apparatus 16 received in step S24 as a retrieval key in step S28.

The examinational information data retrieved from the local database 46 are displayed as a list on the display unit 44 in step S29. Specifically, the CPU 32 as it functions as the list displaying means 53 displays examinational information that is produced by merging the examinational information data newly read from the server 14 and the examinational information data that has already been stored in the local database 46, as a single list on the display unit 44.

In step S30, the operator of the data processing apparatus 18 visually compares the character information (the patient's name, the patient's ID, etc.) and the image (displayed image) of the examined spot (examined region) of the patient with the list of examinational information retrieved from local database 46 on the display unit 44. The operator determines whether the list contains the examinational information data corresponding to the displayed image or not, and enters YES (affirmative) or NO (negative) with the input unit 42.

If the negative answer is entered, then the data processing apparatus 18 displays an examinational information input image on the display unit 44. In step S31, the operator sees the description on the patient's medical record and inputs various items of examinational information, including the patient's acceptance number, the patient's name, the patient's ID, the gender, the date of birth, the patient's height and weight, the blood type, the examined department, the examined region, the imaging technician, the examined data, etc., using the input unit 42 such as a keyboard, etc.

If the answers to steps S27, S30 are affirmative, or after the items of examinational information have been entered in step S30, the data processing apparatus 18 merges the image data in a non-DICOM format received from the medical imaging apparatus 16 in step S24 and the corresponding examinational information data into data in a predetermined format, i.e., data in a DICOM format.

Specifically, the data in the DICOM format is in the form of a tag+data+a tag+data+ . . . +a tag+data. Each of the tags comprises a 4-byte (2 bytes+2 bytes) identifier for identifying either one of the patient's acceptance number, the patient's name, the patient's ID, the gender, the date of birth, the patient's height and weight, the blood type, the examined department, the examined region, the imaging technician, and the examined data. The data following each tag represent examinational information data and image data that are identified by the tag.

More specifically, the former 2 bytes of a tag represent a group number indicative of a patient's attribute, an examined attribute, etc., and the latter 2 bytes of a tag represent an element number in an attribute. For example, a group number indicative of a patient's attribute includes an element number indicative of a patient's name and a patient's ID, and a group number indicative of an examined attribute includes an element number indicative of an acceptance number and an examined date.

The DICOM-format data generated by the data processing apparatus 18 are transmitted from the data processing apparatus 18 through the communication link 12 to the data storage unit 24 and the printer 26 in step S33.

In step S34, the data storage unit 24 stores the transmitted DICOM-format data, and the printer 26 outputs a hardcopy of the diagnosed image.

According to the above embodiment, as described above, the image data captured by the medical imaging apparatus 16 which comprises a non-DICOM modality and read by the data processing apparatus 18, and the examinational information data acquired by the data processing apparatus 18 from the server 14 or the local database 46 are merged into DICOM-format data by the data processing apparatus 18. The comparing means 51 of the data processing apparatus 18 compares the examinational information data newly read from the server 14 and the examinational information data that have already been stored in the local database 46 with each other, and stores the newly read examinational information data into the local database 46 only when the newly read examinational information data have not been stored in the local database 46. Therefore, desired examinational information data can be acquired from the local database 46 of the data processing apparatus 18 when the data need to be converted into DICOM-format data.

Since the data processing apparatus 18 has the periodically data reading means 52 for periodically reading examinational information data from the server 14 for being stored into the local database 46, examinational information data can reliably be acquired from the local database 46 even if the examinational information data have been deleted from the server 14 at the end of the examination.

The data processing apparatus 18 also has the list displaying means 33 for displaying on the display unit 44 a list of examinational information that is produced by merging the examinational information data that are newly read from the server 14 and the examinational information data that have already been stored in the local database 46. Therefore, the user of the data processing apparatus 18 may refer to only one list displayed on the display unit 44, without the need for switching between and selecting one of the list on the server 14 and the list on the local database 46.

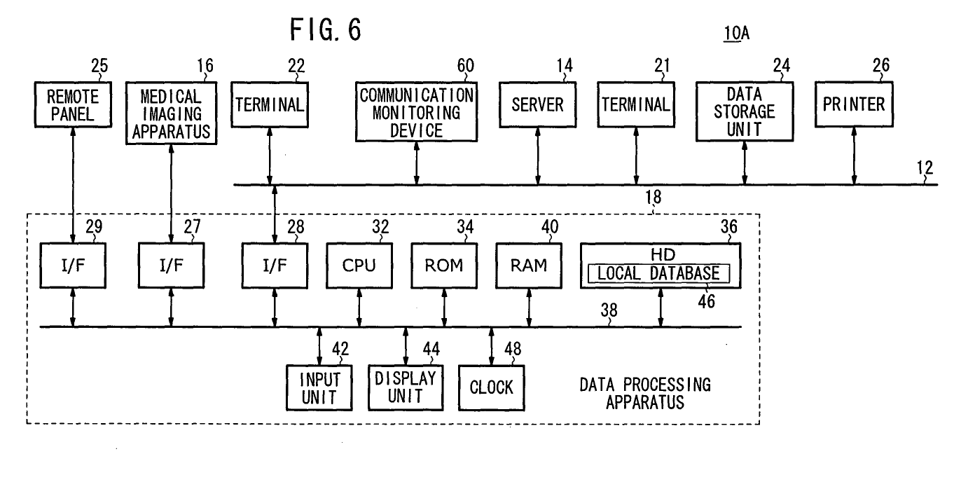

FIG. 6 shows in block form a medical image network system 10A incorporating a system for processing examinational information of medical images according to another embodiment of the present invention.

As shown in FIG. 6, the medical image network system 10A is different from the medical image network system 10 shown in FIG. 2 in that a communication monitoring device 60 serving as a computer terminal is connected to the communication link 12. The communication monitoring device 60 has a function to log communication data between the terminal 22 associated with the medical imaging apparatus 16 and the server 14.

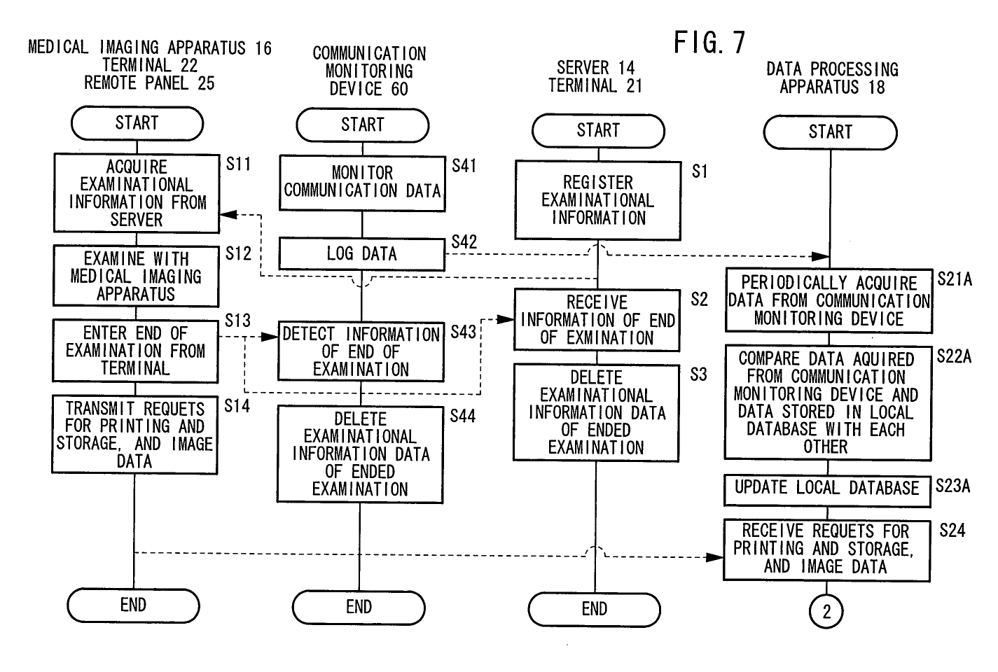

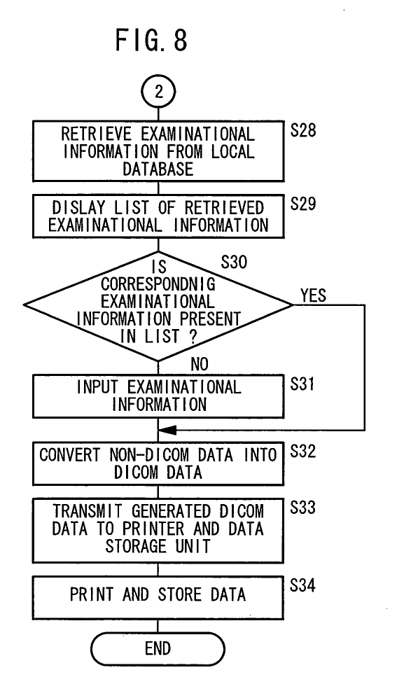

FIGS. 7 and 8 show an operation sequence of the medical image network system 10A shown in FIG. 6.

Those steps shown in FIGS. 7 and 8 which are identical to those shown in FIGS. 4 and 5 are denoted by identical step numbers, and will not be described in detail below.

The communication monitoring device 60 monitors communications between the terminal 22 and the server 14 in step S41 shown in FIG. 7. If there are data transmitted according to data communications between the terminal 22 and the server 14, then the communication monitoring device 60 logs (saves) the data in a memory thereof in step S42. The data communications are performed between the terminal 22 and the server 14 when the medical imaging apparatus 16 is used in step S11. For example, when the imaging technician enters the acceptance number, the patient's name, or the patient's ID into the terminal 22, the terminal 22 acquires the corresponding examinational information data from the server 14 through the communication link 12, and displays the acquired examinational information data on the display unit 22d of the terminal 22. At this time, the examinational information data are logged in the memory of the communication monitoring device 60.

The data processing apparatus 18 periodically retrieves the log of the communication monitoring device 60 to acquire examinational information data therefrom in step S21A.

In step S22A, the CPU 32 as it functions as the comparing means 51 compares the examinational information data newly read from the communication monitoring device 60 in step S21A and the examinational information data that have already been registered in the local database 46 with each other, and stores the examinational information data newly read from the communication monitoring device 60 in step S21A into the local database 46 only when the newly read examinational information data have not been stored in the local database 46. By thus updating the data stored in the local database 46, it is possible to acquire, whenever necessary, examinational information data for identifying images obtained by the medical imaging apparatus 16.

When the end of the examination is detected in step S43, the communication monitoring device 60 deletes the examinational information data of the ended examination from the log data stored in the memory thereof.

After having received the request for printing and storing the image and also received the image data in step S24, the data processing apparatus 18 retrieves examinational information from the local database 46 in step S28, following the connector 2, shown in FIG. 8. The steps S25 through S27 shown in FIGS. 4 and 5 are dispensed with in FIGS. 7 and 8. Other processing details of the operation sequence shown in FIGS. 7 and 8 are identical to those of the operation sequence shown in FIGS. 4 and 5, and will not be described below.

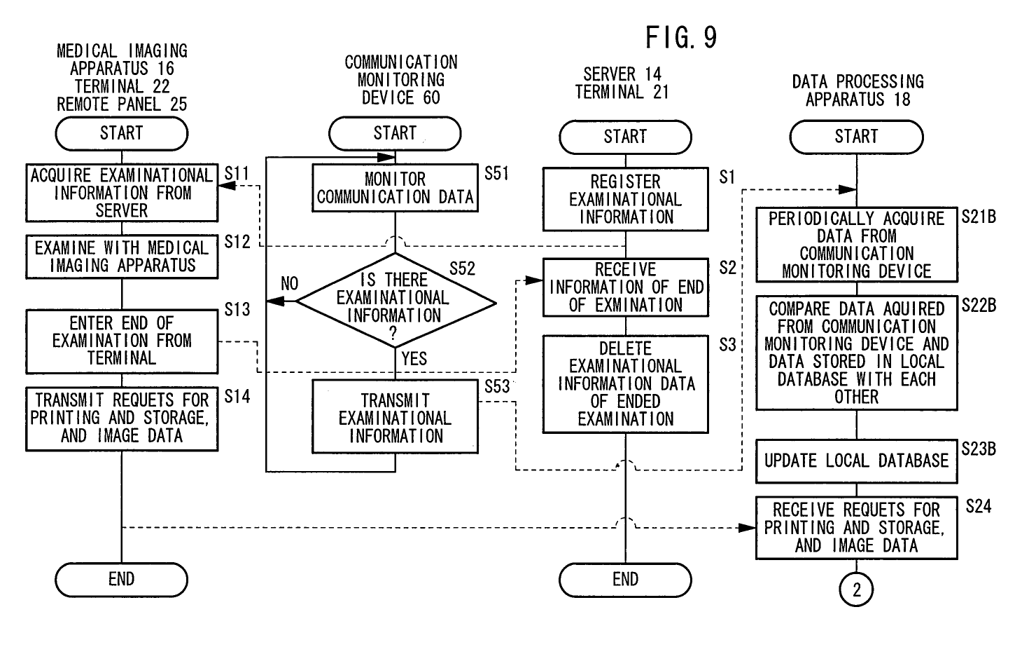

FIG. 9 shows another operation sequence of the medical image network system 10A shown in FIG. 6. According to the operation sequence shown in FIG. 9, the communication monitoring device 60 monitors communications between the terminal 22 and the server 14 in step S51. The communication monitoring device 60 determines whether there are examinational information data contained in data transmitted according to data communications between the terminal 22 and the server 14 or not in step S52. If examinational information data are contained in the data transmitted according to data communications between the terminal 22 and the server 14, then the communication monitoring device 60 transmits the examinational information data to the data processing apparatus 18 in step S53.

At this time, the data processing apparatus 18 acquires the examinational information data transmitted from the communication monitoring device 60 in step S21B.

In step S22B, the CPU 32 as it functions as the comparing means 51 compares the examinational information data newly read from the communication monitoring device 60 in step S21B and the examinational information data that have already been registered in the local database 46 with each other, and stores the examinational information data newly read from the communication monitoring device 60 in step S21B into the local database 46 in step S23B only when the newly read examinational information data have not been stored in the local database 46. By thus updating the data stored in the local database 46, it is possible to acquire, whenever necessary, examinational information data for identifying images obtained by the medical imaging apparatus 16. Processing details of the operation sequence following the connector 2 shown in FIG. 9 are identical to those of the operation sequence shown in FIG. 8, and will not be described below.

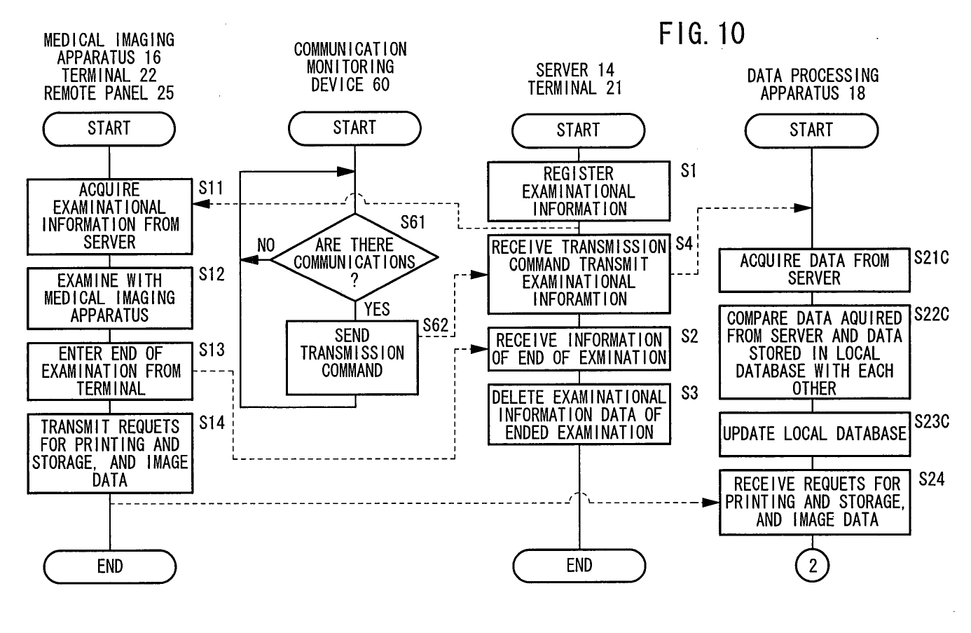

FIG. 10 shows still another operation sequence of the medical image network system 10A shown in FIG. 6. According to the operation sequence shown in FIG. 10, the communication monitoring device 60 monitors communications between the terminal 22 and the server 14 in step S61. If there are data transmitted according to data communications between the terminal 22 and the server 14, then the communication monitoring device 60 sends a command to the server 14 for transmitting examinational information data to the data processing apparatus 18.

In step S4, the server 14 copies predetermined data included in the examinational information data registered at the present time or all the examinational information data registered at the present time, and transmits the copied examinational information data to the data processing apparatus 18.

In step S21C, the data processing apparatus 18 acquires the examinational information data transmitted from the server 14.

In step S22C, the CPU 32 as it functions as the comparing means 51 compares the examinational information data newly read from the communication monitoring device 60 in step S21C and the examinational information data that have already been registered in the local database 46 with each other, and stores the examinational information data newly read from the communication monitoring device 60 in step S21C into the local database 46 in step S23C only when the newly read examinational information data have not been stored in the local database 46. By thus updating the data stored in the local database 46, it is possible to acquire, whenever necessary, examinational information data for identifying images obtained by the medical imaging apparatus 16. Processing details of the operation sequence following the connector 2 shown in FIG. 10 are identical to those of the operation sequence shown in FIG. 8, and will not be described below.

According to the present invention, as described above, since examinational information for identifying images that are obtained by the medical imaging apparatus is stored in the local database, the examinational information data can be acquired from the local database whenever necessary.

Although certain preferred embodiments of the present invention have been shown and described in detail, it should be understood that various changes and modifications may be made therein without departing from the scope of the appended claims.

What is claimed is:

1. A data processing apparatus in a system for processing examinational information of medical images, said system having a server for storing and managing examinational information data for identifying an image obtained by a medical imaging apparatus, and said data processing apparatus for merging data of the image obtained by said medical imaging apparatus and the examinational information data from said server into data in a predetermined format, said server and said data processing apparatus being connected to each other by a communication link, said data processing apparatus comprising:
a local database for storing and managing said examinational information data; and
comparing means for comparing examinational information data newly read from said server and examinational information data that have already been stored in said local database with each other, and storing the newly read examinational information data into said local database only when the newly read examinational information data have not been stored in said local database.

2. A data processing apparatus according to claim 1, further comprising:
periodically data reading means for periodically reading said examinational information data from said server.

3. A data processing apparatus according to claim 1, further comprising:
list displaying means for displaying, on a display unit, a list of examinational information that is produced by merging examinational information data newly read from said server and examinational information data that have already been stored in said local database.

4. A data processing apparatus according to claim 2, further comprising:
list displaying means for displaying, on a display unit, a list of examinational information that is produced by merging examinational information data newly read from said server and examinational information data that have already been stored in said local database.

5. A system for processing examinational information of medical images, said system having a server for storing and managing examinational information data for identifying an image obtained by a medical imaging apparatus, and a data processing apparatus for merging data of the image obtained by said medical imaging apparatus and the examinational information data from said server into data in a predetermined format, said server and said data processing apparatus being connected to each other by a communication link, said data processing apparatus comprising:
a local database for storing and managing said examinational information data; and
comparing means for comparing examinational information data newly read from said server and examinational information data that have already been stored in said local database with each other, and storing the newly read examinational information data into said local database only when the newly read examinational information data have not been stored.

6. A system according to claim 5, further comprising:
a terminal connected to said communication link for receiving and outputting examinational information data that have been stored in said server when the medical imaging apparatus is used; and
a communication monitoring device connected to said communication link for logging communication data transmitted between said terminal and said server,
wherein said communication monitoring device transmits the examinational information data to said data processing apparatus when said communication monitoring device detects reception by said terminal of said examinational information data from said server.

7. A system according to claim 5, further comprising:
a terminal connected to said communication link for receiving and outputting examinational information data that have been stored in said server when the medical imaging apparatus is used; and
a communication monitoring device connected to said communication link for monitoring data communications between said terminal and said server,
wherein said communication monitoring device sends a command to said server to copy predetermined data included in the examinational information data stored in said server to said local database when data communications between said terminal and said server are detected.
